(19) United States
(12) Patent Application Publication
(10) Pub. No.: US 2008/0197051 A1
(43) Pub. Date: Aug. 21, 2008

(54) Desulfurizing Agent for Removing Organic Sulfur Compounds, Preparation Method thereof and Method for Removing Organic Sulfur Compounds Using the Same

(75) Inventors: Byong Sung Kwak, Daejeon (KR); Young Seek Yoon, Daejeon (KR); Jin Hong Kim, Daejeon (KR); Il Su Kim, Daejeon (KR); Keun Seob Choi, Daejeon (KR); Jin Hwan Bang, Daejeon (KR); Ki Won Jun, Daejeon (KR); Hyung Tae Kim, Daejeon (KR); Seung Moon Kim, Daejeon (KR)

Correspondence Address: DARBY & DARBY P.C., P.O. BOX 770, Church Street Station, New York, NY, 10008-0770, US

(73) Assignee: SK ENERGY CO., LTD., Seoul (KR)

(21) Appl. No.: 12/063,053

(22) PCT Filed: Jul. 31, 2006
(86) PCT No.: PCT/KR2006/002995

§ 371 Date: Feb. 6, 2008

(30) Foreign Application Priority Data
Aug. 12, 2005 (KR) 10-2005-0074393

(51) Int. Cl. C10G 29/04; B01J 20/02

(52) U.S. Cl. 208/246; 502/414

(57) ABSTRACT

Disclosed herein are a desulfurizing agent for removing organic sulfur compounds, a preparation method thereof, and a method for removing organic sulfur compounds using the same. The desulfurizing agent consists of a copper-zinc-aluminum complex free of alkaline metal, with a large surface area. When being contacted with organic sulfur compounds, such as t-butylmercaptan, tetrahydrothiophene, dimethylsulfide, etc., the desulfurizing agent exhibits excellent desulfurization ability and is not de-graded especially at high temperatures as high as 150˜350° C.

### TECHNICAL FIELD

The present invention relates to a desulfurizing agent (also known as desulfurizing adsorbent) for removing organic sulfur compounds from hydrocarbon fuels effectively at high temperatures, a preparation method thereof and a method for removing organic sulfur compounds using the same. More particularly, the present invention relates to an alkaline metal-free desulfurizing agent for removing organic sulfur compounds, comprising a copper-zinc-aluminum composite material which can be prepared through a co-precipitation method using an alkaline metal-free compound as a co-precipitant. The desulfurizing agent has a large surface area and can effectively remove organic sulfur compounds especially at high temperatures. The present invention is also concerned with a method for preparing the desulfurizing agent and a method for removing organic sulfur compounds using the desulfurizing agent.

### BACKGROUND ART

Organic sulfur compounds, such as t-butylmercaptan (TBM), tetrahydrothiophene (THT), dimethylsulfide (DMS), ethylmethylsulfide (EMS), etc., are contained in liquefied natural gas (LNG), liquefied petroleum gas (LPG) and liquid fuels. Some of the processes employing these hydrocarbon fuels as feeds for steam reforming adopt metal or noble metal-based catalysts. It is, however, reported that the reforming catalysts are likely to be not only poisoned with sulfur, but also have sulfur compounds formed thereon even at concentrations as low as parts per million [McCarty et al.; J. Chem. Phys. Vol. 72, No. 12, 6332, 1980, J. Chem. Phys. Vol. 74, No. 10, 5877, 1981]. According to the report, when used with hydrocarbon fuels as feed for steam reforming, Ni- or Ru-based catalysts have most surfaces thereof poisoned with sulfur even at a sulfur content of as low as 0.1 ppm due to the high sulfur adsorptivity of Ni or Ru and thus are degraded in catalytic performance. Also, other metals are reported to readily have surface sulfur compounds on the surface thereof and be poisoned with sulfur. Therefore, because sulfur poisoning degrades the catalytic efficiency of the reforming catalysts, desulfurization is a process indispensable for the reformation of the hydrocarbon fuels into hydrogen or synthetic gas.

There are two desulfurization processes known to remove organic sulfur compounds from hydrocarbon fuels: hydrodesulfurization and adsorptive desulfurization. In a hydrodesulfurization process, hydrogen is added to hydrocarbon fuels to decompose organic sulfur compounds into hydrogen sulfide in the presence of a Co—Mo-based catalyst, followed by absorbing the hydrogen sulfide on a desulfurizing agent, such as zinc oxide or ferric oxide, thereby lowering the sulfur content down to 0.1 ppm. However, even 0.1 ppm of sulfur has a negative influence on the reformation of the fuels. Thus, the sulfur content must be decreased to much less than 0.1 ppm, which is achievable through and thus requires deep desulfurization. Hydrodesulfurization, in addition, requires an operation temperature of as high as 350° C., making it difficult to reduce the time required for start-up. Further, a part of the hydrogen produced through a reformer must be fluxed before being supplied to a desulfurizing reactor in a desulfurization process.

A combination of hydrodesulfurization and adsorptive desulfurization was suggested [Nagase et al., Catal. Today Vol. 45, 393, 1998]. This combined method is suitable for the desulfurization of LPG which is too high in sulfur content for adsorption desulfurization alone to treat, and has an advantage of prolonging the changing cycle of adsorbents upon the desulfurization of LNG.

Active carbon or zeolite materials are known as adsorbents for removing organic sulfur compounds. Through intensive research, however, the present inventors have found that the adsorptive desulfurization using active carbon or zeolite-based adsorbents is useful at moderate or low temperatures, but is significantly decreased in adsorption capacity at 100° C. or higher. In the combined method of hydrodesulfurization and adsorptive desulfurization, the effluent gas after hydrodesulfurization cannot be treated because its temperature is as high as 200 to 350° C.

Tokyo Gas, Japan, developed active carbon fibers for use as an adsorbent which are excellent in adsorption capacity for organic sulfur compounds, and hydrophobic zeolite, ion-exchanged with one or two transition metals of Ag, Fe, Cu, Ni and Zn, for use as a desulfurizing adsorbent for removing dimethyl sulfide (DMS) from fuel gas (Japanese Pat. Laid-Open Nos. 2001-19984 and 2001-286753). These desulfurizing adsorbents are useful in removing organic sulfur compounds by adsorption at room temperature and low temperatures, but show low ability at high temperatures. Osaka Gas, Japan, developed a copper-zinc desulfurizing adsorbent by a co-precipitation method, which is applied for the removal of thiophenes at high temperatures (U.S. Pat. No. 6,024,798). Typically, an alkali metal-containing co-precipitation agent (sodium carbonate, sodium acetate) is used to prepare copper-zinc oxides by co-precipitation. However, it has been found by the present inventors that the presence of alkali metal has a strongly negative influence on the ability of the desulfurizing agent to remove organic sulfur compounds.

### DISCLOSURE

### Technical Problem

Leading to the present invention, intensive and thorough research into desulfurizing agents, conducted by the present inventors, aiming to solve the problems encountered in previous techniques, resulted in the finding that the use of an alkaline-free compound as a co-precipitant and a reduction treatment with hydrogen can produce a copper-zinc-aluminum composite material which is highly useful as a desulfurizing adsorbent capable of effectively removing organic sulfur compounds, such as mercaptans, thiophenes, sulfides, etc.

Therefore, it is an object of the present invention to provide a desulfurizing adsorbent, free of alkaline metal, which has a large surface area and can effectively remove organic sulfur compounds without a decrease in desulfurization ability even at high temperatures.

It is another object of the present invention to provide a method for preparing an alkaline metal-free desulfurizing adsorbent for removing organic sulfur compounds, which has a large surface area and does not decrease in desulfurization ability at high temperatures.

It is a further object of the present invention to provide a method for effectively removing organic sulfur compounds using the desulfurizing adsorbent.

### Technical Solution

In order to achieve the above objects, an aspect of the present invention provides a desulfurizing agent for removing organic sulfur compounds, comprising a copper-zinc-aluminum composite material free of alkaline metal.

In order to achieve the above objects, another aspect of the present invention provides a method for preparing a desulfurizing agent for removing organic sulfur compounds, comprising: simultaneously adding an aqueous solution containing a copper compound, a zinc compound and an aluminum compound and an aqueous solution of a non-alkaline metal compounds dropwise to deionized water to form a precipitate; filtering out and drying the precipitate; calcining the precipitate; and reducing the precipitate.

In order to achieve the above objects, a further aspect of the present invention provides a method for removing organic sulfur compounds, comprising contacting the organic sulfur compounds with the desulfurizing agent of claim 1 at 150˜350° C.

### Advantageous Effect

The alkaline metal-free desulfurizing agent consisting of copper oxide-zinc oxide-aluminum oxide in accordance with the present invention is highly effective for removing organic sulfur compounds from liquefied petroleum gas, liquefied natural gas, and liquid fuels. Therefore, the desulfurizing agent makes a great contribution to the longevity of catalysts for use in processing hydrocarbons.

### Best Mode

Below, a detailed description will be given of the present invention.

In the present invention, a copper-zinc-aluminum-based desulfurizing adsorbent is prepared by a co-precipitation process using an alkali-free compound as a precipitation agent and by a reducing treatment with hydrogen. Featuring a large surface area, the desulfurizing adsorbent, free of alkaline metal, is suitable for removing organic sulfur compounds at high temperatures.

In an embodiment of the present invention, a desulfurizing agent for removing organic sulfur compounds is prepared by a co-precipitation method in which an aqueous solution containing a molar ratio of 1:0.5-2:0.1-1 copper compound : zinc compound : aluminum compound and a precipitation agent solution free of alkali compounds are dropwise added to deionized water simultaneously to form a precipitate.

In the adsorbent according to the present invention, the copper compound acts to primarily adsorb organic sulfur compounds, the zinc compound bonds with the adsorbed 2 0 organic sulfur compounds through a strong zinc-sulfur linkage to further increase the desulfurization capacity, and the aluminum compound aids the copper-zinc oxides to disperse so as to increase the effective surface area. Playing these respective roles, the three metal ingredients must be mixed in a proper combination to give an effective desulfurizing agent.

Therefore, the molar ratios of the copper compound, the zinc compound and the aluminum compound are preferably on the order of 1:0.5-2:0.1-1 in accordance with the present invention. If the molar ratio is out of this range, the metal ingredients are reduced in their adsorption capacity.

When mixed together, the copper compound, the zinc compound and the aluminum compound are preferably in the form of a salt of nitric acid or acetic acid, or in the form of hydroxide. For example, the copper compound may be in the form of copper nitrate or copper acetate. The zinc compound may be zinc nitrate or zinc acetate. As for the aluminum compound, aluminum nitrate or aluminum hydroxide may be used. The precipitate obtained by filtration may be or may be not washed with deionized water before being dried and calcined. After being extruded, the precipitate is calcined at 200-500° C. in an oxygen atmosphere to afford a copper oxide-zinc oxide-aluminum oxide composite material as a desulfurizing adsorbent.

The data of the study conducted by the present inventors show that when an alkaline metal compound, such as sodium carbonate or potassium carbonate, is used as a co-precipitation agent, not only is it very difficult to effectively remove the alkaline metal from the precipitate, but also the alkaline metal remaining in the precipitate interrupts the dispersion of the copper oxide-zinc oxide-aluminum oxide to decrease the surface area of the desulfurizing agent and significantly degrade the desulfurization capacity of the desulfurizing agent.

Accordingly, the present invention excludes the use of alkaline metal, but employs non-alkali compounds as precipitation agents. In this regard, preferable is the use of ammonium carbonate in the preparation of a desulfurizing adsorbent, in accordance with the present invention.

Further, an activation process in which a reducing treatment is performed for 1-10 hours at 200˜500° C. for 1˜10 hours in a hydrogen atmosphere is highly effective for increasing the capacity of the desulfurizing agent thus obtained. This is because the reducing treatment confers upon the copper a metal state effective for scavenging sulfur compounds. A reducing treatment temperature less than 200° C. causes the copper to be reduced insufficiently, which leads to insufficient activation of the desulfurizing agent. On the other hand, when the activation process is conduced at a temperature over 500° C., the desulfurizing agent decreases in surface area. Insufficient reduction results, as well, when the reducing treatment is performed for a period of time less than 1 hour. A time period of reduction, if longer than the upper limit, unnecessarily wastes the reducing agent hydrogen after sufficient reduction has already taken place.

The desulfurizing agent thus prepared in accordance with the present invention is free of alkaline metal and has a surface area greater than that of conventional desulfurizing agents, amounting to 80 to 160 m²/g.

The copper-zinc-aluminum desulfurizing agent according to the present invention was assayed for desulfurization or adsorption capacity in a temperature range from 50 to 350° C. In an embodiment, the copper oxide-zinc oxide-aluminum oxide desulfurizing adsorbent according to the present invention was measured for bulk density and charged in a volume of 1 ml in an test tube 1 cm in inner diameter. Passage of a nitrogen gas with a hydrogen content of 2˜5% at a flow rate of 30 ml/min for 3 hours through the charged tube activated the desulfurizing adsorbent. Then, methane gas (CH₄) with an organic sulfur compound-containing odorant was fed through the adsorption tube at a GHSV of 6,000 h⁻¹ and the effluent therefrom was quantitatively analyzed for sulfur compounds using gas chromatography with the aid of a PFPD. The time taken to detect the organic sulfur compound to a concentration of 0.1 ppm or higher was used as an indicator showing the adsorption capacity of the desulfurizing adsorbent. Its adsorption ability or desulfurization ability was expressed as a weight percentage of the adsorbed sulfur relative to the total organic sulfur compound adsorbed (wt % gₛ/g_{ads.}).

According to the study of the present inventors, the copper-zinc-aluminum desulfurizing agent of the present invention was found to exhibit particularly high desulfurization ability for hydrocarbon gas containing organic sulfur compounds such as mercaptans, thiophenes, and sulfides at 150˜350° C. This is because it is difficult to form an effective chemical bond between zinc and sulfur at lower than 150° C. and to form a primary chemical adsorption between an organic sulfur compound and copper at higher than 350° C.

### Mode for Invention

A better understanding of the present invention may be realized with the following examples, which are set forth to illustrate, but are not to be construed to limit the present invention.

### EXAMPLE 1

50 ml of a 2.3 M aqueous solution containing a molar ratio of 1:1:0.3 copper nitrate:zinc nitrate:aluminum nitrate and 50 ml of a 2.45 M aqueous ammonium carbonate solution were added dropwise to deionized water, simultaneously, so as to form precipitates. They are filtered out, injection molded, and dried at 110° C. for 12 hours, followed by calcining the molded subject at 300° C. for 12 hours to afford a copper oxide-zinc oxide-aluminum oxide composite material as a desulfurizing agent. This was measured to have a surface area of 142.32 m²/g and an alkaline metal content of 0%.

The desulfurizing agent consisting of copper oxide-zinc oxide-aluminum oxide was measured for bulk density and charged in an amount of 1 ml in a quartz tube having an inner diameter of 1 cm. By a pre-treatment in which a nitrogen gas with a hydrogen content of 5% was passed at a speed of 30 ml/min at 200° C. for 3 hours through the quartz tube, the desulfurizing agent was activated. A methane gas (CH₄) containing 23.9 ppm of TBM (t-butylmercaptan) and 55.4 ppm of THT (tetrahydrothiophene) was fed at a GHSV of 6,000 h⁻¹ at 250° C. through the adsorption tube charged with the activated desulfurizing agent and the effluent methane gas was quantitatively analyzed for sulfur compound content using PFPD/GC. A shorter time period taken to detect either TBM or THT to a concentration of 0.1 ppm was defined as an adsorption saturation time of the organic sulfur compound. The desulfurization ability of the desulfurizing agent was expressed as the amount of the adsorbed sulfur relative to the total amount of the adsorbed organic sulfur compounds TBM and THT for the adsorption saturation time period (wt % gₛ/g_{ads.}). The desulfurization ability of the desulfurization agent was measured to be 1.82 wt % gₛ/g_{ads} for the odorant TBM or THT.

### EXAMPLE 2

The same procedure as in Example 1 was performed with the exception that a methane gas containing 94.1 ppm of DMS as an odorant was used and the adsorption saturation time was defined as the time taken to detect DMS to a concentration of 0.1 ppm. The desulfurization ability of the desulfurizing agent was measured to 0.77 wt % gₛ/g_{ads.} for DMS.

### EXAMPLE 3

The same procedure as in Example 1 was performed with the exception that a methane gas containing 100 ppm of TBM was used and the adsorption saturation time was defined as the time taken to detect TBM to a concentration of 0.1 ppm. The desulfurization ability of the desulfurizing agent was measured to be 30.4 wt % gₛ/g_{ads.} for TBM.

### EXAMPLE 4

The same procedure as in Example 1 was performed with the exception that the methane gas was passed through the tube at 200° C. The desulfurization ability of the desulfurizing agent was measured to be 1.55 wt % gₛ/g_{ads.}.

### EXAMPLE 5

The same procedure as in Example 1 was performed with the exception that the methane gas was passed through the tube at 300° C. The desulfurization ability of the desulfurizing agent was measured to be 1.39 wt % gₛ/g_{ads.}.

### COMPARATIVE EXAMPLE 1

The same procedure as in Example 1 was performed with the exception that sodium carbonate, instead of ammonium carbonate, was used as a precipitation agent. The desulfurizing agent thus obtained was found to have a surface area of 18.38 m²/g and an alkaline metal content of 8.45%. Its desulfurization ability was measured to be 0.02 wt % gₛ/g_{ads.}.

### COMPARATIVE EXAMPLE 2

The same procedure as in Example 1 was performed with the exception that sodium carbonate, instead of ammonium carbonate, was used as a precipitation agent and a process of washing the precipitates with deionized water heated to 80° C. was conduced after the filtration. The desulfurizing agent thus obtained was found to have a surface area of 60.32 m²/g and an alkaline metal content of 0.035%. Its desulfurization ability was measured to be 0.61 wt % gₛ/g_{ads.}.

### COMPARATIVE EXAMPLE 3

The same procedure as in Example 2 was performed with the exception that sodium carbonate, instead of ammonium carbonate, was used as a precipitation agent and a process of washing the precipitates with deionized water heated to 80° C. was conduced just after the filtration. The desulfurization ability of the desulfurizing agent thus obtained was measured to be 0.27 wt % gₛ/g_{ads.}.

### COMPARATIVE EXAMPLE 4

The same procedure as in Example 2 was performed with the exception that potassium carbonate, instead of ammonium carbonate, was used as a precipitation agent and a process of washing the precipitates with deionized water heated to 80° C. was conduced just after the filtration. The desulfurizing agent thus obtained was found to have a surface area of 76.3 m²/g and an alkaline metal content of 0.043%. Its desulfurization ability was measured to be 0.24 wt % gₛ/g_{ads.}.

### COMPARATIVE EXAMPLE 5

The same procedure as in Example 2 was performed with the exception that the desulfurizing agent was not allowed to undergo the pre-treatment for activation thereof. The desulfurization ability of the desulfurizing agent thus obtained was measured to be 0.06 wt % gₛ/g_{ads.}.

### COMPARATIVE EXAMPLE 6

The same procedure as in Example 1 was performed with the exception that the methane gas was passed through the tube at 50° C. The desulfurization ability of the desulfurizing agent thus obtained was measured to be 0.41 wt % gₛ/g_{ads.}.

### COMPARATIVE EXAMPLE 7

An activated carbon with 5% of copper ions impregnated therein was used as a desulfurizing agent was assayed for desulfurizing adsorption in a manner similar to that of Example 2. Its desulfurizing ability was measured to be 0.33 wt % gₛ/g_{ads.}.

### COMPARATIVE EXAMPLE 8

An activated carbon with 5% of copper ions impregnated therein was used as a desulfurizing agent was assayed for desulfurizing adsorption in a manner similar to that of Example 3. Its desulfurizing ability was measured to be 0.19 wt % gₛ/g_{ads.}.

When considering the data from Example 1 and Comparative Example 1, the use of ammonium carbonate as a precipitation agent brings about a great improvement in surface area and desulfurization ability for THT+TBM, compared to the use of sodium carbonate. The desulfurizing agent of Comparative Example 2, although a process of washing with hot water removes sodium ions to some extent so as to increase the surface area and the desulfurization ability, compared to that of Comparative Example 1, exhibits only 30% of the desulfurization ability of Example 1.

When considering the data from Example 2 and Comparative Examples 3 and 4 demonstrate, ammonium carbonate is much more effective for increasing the desulfurization ability for DMS than is sodium carbonate or potassium carbonate. The data from Example 2 and Comparative Example 5 demonstrate that the activation process by reduction treatment makes a great contribution to the desulfurization ability of the desulfurizing agent

Comparison of Examples 1, 4 and 5 with Comparative Example 6 gives a good knowledge of the change of desulfurization ability with temperature. Desulfurization at 200˜300° C. ensures a much greater desulfurization ability than that at as low as 50° C.

Activated carbon impregnated with copper ions, a conventional desulfurizing agent, is significantly lower in removal rate of DMS and TBM at 250° C. than is the copper-zinc-aluminum oxide composite material according to the present invention, as recognized by comparison between Example 2 and Comparative Example 7 and between Example 3 and Comparative Example 8.

1. A desulfurizing agent for removing organic sulfur compounds, comprising a copper-zinc-aluminum composite material free of alkaline metal.

2. The desulfurizing agent as defined in claim 1, wherein the copper-zinc-aluminum composite material has a molar ratio of 1:0.5˜2:0.1˜1 copper:zinc:aluminum.

3. The desulfurizing agent as defined in claim 1, wherein the desulfurizing agent has a surface area of 80 to 160 m²/g.

4. A method for preparing a desulfurizing agent for removing organic sulfur compounds, comprising:
simultaneously adding an aqueous solution containing a copper compound, a zinc compound and an aluminum compound and an aqueous solution of a non-alkaline metal compounds dropwise to deionized water to form a precipitate;
filtering out and drying the precipitate;
calcining the precipitate; and
reducing the precipitate.

5. The method as defined in claim 4, wherein the non-alkaline metal compound is ammonium carbonate.

6. The method as defined in claim 4, wherein the copper compound, the zinc compound and the aluminum compound each is in the form of a salt of nitric acid or acetic acid or in the form of hydroxide.

7. The method as defined in claim 4, wherein the copper compound, the zinc compound and the aluminum compound are added at a molar ratio of 1:0.5˜2:0.1˜1.

8. The method as defined in claim 4, wherein the backing is performed at 200˜500° C. for 1˜20 hours in an oxygen atmosphere.

9. The method as defined in claim 4, wherein the reducing is performed at 200˜500° C. for 1˜10 in a hydrogen atmosphere.

10. A method for removing organic sulfur compounds, comprising contacting the organic sulfur compounds with the desulfurizing agent of claim 1 at 150˜350° C.

11. The method as defined in claim 10, wherein the organic sulfur compounds are selected from a group consisting of t-butylmercaptan, tetrahydrothiophene, dimethylsulfide and combinations thereof.
